(19) United States
(12) Patent Application Publication
(10) Pub. No.: US 2006/0134594 A1
(43) Pub. Date: Jun. 22, 2006

(54) Grading terminal device, grading promotion program, grading promotion method, and grading terminal system

(75) Inventor: Masanori Yokota, Kanagawa (JP)

Correspondence Address: YOUNG & THOMPSON, 745 SOUTH 23RD STREET, 2ND FLOOR, ARLINGTON, VA, 22202, US

(73) Assignee: NTS, INC, YOKOHAMA-SHI (JP)

(21) Appl. No.: 10/559,414

(22) PCT Filed: Jun. 4, 2004
(86) PCT No.: PCT/JP04/07812

§ 371 Date: Dec. 5, 2005

(30) Foreign Application Priority Data
Jun. 5, 2003 (JP) 2003-161416

(51) Int. Cl. G09B 7/00

(52) U.S. Cl. 434/353; 434/362

(57) ABSTRACT

To reduce the burden on a grader, as well as to improve design freedom. A grading terminal device body 1 is provided with a LCD 31 for identifying and displaying an area corresponding to an answer column to be graded among the answer columns provided on an answer sheet, a keyboard unit 33 for entering a grading result of an answer entered in the answer column corresponding to the area identified and displayed on the LCD 31, a printer section 50 for carrying in the answer sheet to print the grading result entered from the keyboard unit 33, followed by carrying-out thereof, and an arithmetic control section 65 responsible for operation control of the LCD 31, the keyboard unit 33, and the printer section 50.

### TECHNICAL FIELD TO WHICH THE INVENTION PERTAINS

The present invention relates to a grading terminal device, a grading promotion program, a grading promotion method, and a grading terminal system, and in particular to a grading terminal device installed in a cram school, and the like, a grading promotion program, a grading promotion method, and a grading terminal system.

### BACKGROUND ART

Heretofore, some grading terminal devices installed in cram schools, and the like have made it possible to easily achieve generation of an academic achievement table and its output based on tabulation of all examinees' academic achievement by automatically making grading in arithmetic processing, and storing the results thereof in a storage medium, followed by evaluating and printing the grading with respect to the answer sheet itself based on this stored data by that, for example, the answer sheet is placed on a grading display section, a display portion positioned by relating to each answer column of the answer sheet is formatted in advance, and entry is provided by evaluation keyboard operation while sequentially tracing the answer columns.

A plurality of such grading terminal devices were installed, and the comprehensive academic achievement table of all examinees was generated in a main computer by entering data obtained by grading made in each grading terminal device into the main computer through a predetermined storage medium.

Also, they have been provided with an operation content display section in which the type of the answer sheet is blinked by the emitting diode LED (Patent Document 1)

[Patent Document 1]

Japanese Patent Publication No. 5-74825 (page 3, column 5, line 7 to line 24)

### DISCLOSURE OF THE INVENTION

### PROBLEMS TO BE SOLVED BY THE INVENTION

However, the prior art was provided with two display sections of a grading display section and an operation content display section. Thus, in order to enable viewing of each display content of the grading display section and the operation content display section without little change in a grader's eyes, it was necessary to provide the grading display section and the operation content display section in closer positions to each other Accordingly, there was room for improvement due to problems with restrictive design freedom, for example, difficulty in selection of lay out, for example, a printer section had to be set up adjacent to the grading display section, or the devices were grown in size.

Also, in the prior art, since the data obtained by the grading were entered into the main computer through the predetermined storage medium to generate the comprehensive academic achievement table of all the examinees, the comprehensive academic achievement table of all the examinees could not be generated without having to use the manpower, and reduction of the burden on the grader was required in this respect.

For this purpose, an object of the present invention is to provide reduction of the burden on a grader.

Furthermore, an object of the present invention is to provide improvement in design freedom.

### MEANS FOR SOLVING THE PROBLEMS

In order to achieve said objects, the grading terminal device according to the present invention is provided with a display section for identifying and displaying an area corresponding to an answer column to be graded among the answer columns provided on an answer sheet, as well as for displaying a question number corresponding to the area, and an examinee's number entered on said answer sheet, a grading result entry section for entering a grading result of an answer entered in the answer column corresponding to the area identified and displayed on said display section, and a printer section for carrying in said answer sheet to print the grading result entered by said grading result entry section, followed by carrying-out thereof.

For this reason, all that a grader has to do is set an answer sheet to be printed before grading, thus providing reduced burden on the grader.

Said printer section is provided inside a grading terminal device body, and at the same time, on the rear surface side of said display section, a carry-in source of said answer sheet being rendered an upper portion of said display section, and a carry-out destination of said display section being rendered a lower portion of said display section.

In this way, three-dimensional configuration of the printer section and the display section allow design freedom to be improved, and devices to be miniaturized in size.

The grading terminal device according to the present invention is also provided with an arithmetic control section in which a grade point of the answer entered on said answer sheet is calculated based on the grading result entered by said grading result entry section, and preset allocation grade data, and the calculated grade point is output to a network to which a plurality of grading terminal device bodies are connected to each other, as well as a grade point of an answer entered on other answer sheet output from the network side is entered.

In this way, the burden on the grader is reduced by enabling the generation of the comprehensive academic achievement table of all the examinees without having to use the manpower.

Said display section is a touch panel type display section, allowing at least one entry, or one display of said examinee's number, information for identifying a grader who makes said grading, the grade of an examinee who has entered the answer on said answer sheet, an examination subject of the examinee, and a format of said answer column.

In this way, the design freedom is improved, and the devices are miniaturized in size by providing the display section with an input function.

The grading terminal system according to the present invention is provided with a network in which any of the aforementioned grading terminal devices are connected to each other to communicate grade points calculated in said each grading terminal device, and information processing equipment in which said each grading terminal device and said network are relayed to transmit the grade points output from said each grading terminal device to said network side to output the grade points transmitted from the network side to the each grading terminal device.

In this way, the burden on the grader is reduced by enabling the generation of the comprehensive academic achievement table of all the examinees without having to use the manpower.

The grading promotion program according to the present invention allows the arithmetic control section mounted on the grading terminal device to execute a step of instructing to identify and display the area corresponding to the answer column to be graded among the answer columns provided on the answer sheet, as well as to display the question number corresponding to the area, and the examinee's number entered on said answer sheet, and a step of instructing to carry in said answer sheet after entry of the grading result of the answer entered in the answer column corresponding to said identified and displayed area to print the grading result entered by said grading result entry section, followed by the carrying-out thereof.

For this reason, all that the grader has to do is set the answer sheet to be printed before grading, thus providing the reduced burden on the grader.

Also, the grading promotion program according to the present invention allows the arithmetic control section mounted on the grading terminal device to execute a step of instructing to calculate a grade point of the answer entered on said answer sheet based on said grading result and preset allocation grade data, a step of instructing to output said calculated grade point to the network to which the plurality of grading terminal device bodies are connected to each other, and a step of instructing to enter the grade point of the answer entered on other answer sheet output from said network side.

In this way, the burden on the grader is reduced by enabling the generation of the comprehensive academic achievement table of all the examinees without having to use the manpower.

Furthermore, the grading promotion program, in which the display section for displaying said identifying and displaying, said question number, and said examinee's number is a touch panel type display section, allows the arithmetic control section mounted on the grading terminal device to execute a step of instructing to display a screen prompting at least one entry of said examinee's number, the information for identifying the grader who makes said grading, the grade of the examinee who has entered the answer on said answer sheet, the examination subject of the examinee, and the format of said answer column, or a step of instructing to display at least one of said examinee's number, the information for identifying said grader, the grade of said examinee, said examination subject, and the format of said answer column.

In this way, the design freedom is improved, and the devices are miniaturized in size by providing the display section with the input function.

The grading promotion method according to the present invention allows the arithmetic control section mounted on the grading terminal device to execute a step of instructing to identify and display the area corresponding to the answer column to be graded among the answer columns provided on the answer sheet, as well as to display the question number corresponding to the area, and the examinee's number entered on said answer sheet, and a step of instructing to carry in said answer sheet after the entry of the grading result of the answer entered in the answer column corresponding to said identified and displayed area to print the grading result entered by said grading result entry section, followed by the carrying-out thereof.

### EFFECTS OF THE INVENTION

According to the present invention, all that a grader has to do is set an answer sheet to be printed before grading, enabling generation of a comprehensive academic achievement table of all examinees without having to use manpower, and thus providing reduced burden on the grader.

In addition, according to the present invention, a printer section and a display section are configured in three dimensions, and the display section is provided with an input function, thus providing improved design freedom.

### BEST MODE FOR CARRYING OUT THE INVENTION

Hereinafter, an embodiment of the present invention will be described with reference to the accompanying drawings.

### DESCRIPTION OF CONFIGURATION

FIG. 1 is a front view of a grading terminal device of an embodiment of the present invention.

FIG. 2 is a back view of the grading terminal device shown in FIG. 1.

FIG. 3 is a top view of the grading terminal device shown in FIG. 1.

FIG. 1 shows a grading terminal device body 1 provided with an upper casing portion 14 and a lower casing portion 15, a sheet storage cabinet 12 located in the center of the front surface of the grading terminal device 1, a sheet discharge port 13 located in the upper portion of the sheet storage cabinet 12, a flexible disk drive (hereinafter, referred to as “FDD”) 11 located rightward of the front surface of the lower casing portion 15, a power switch 10 provided in the vicinity of the FDD 11, a liquid crystal display section with a touch panel (hereinafter, referred to as “LCD”) 31 provided in the center of the upper surface of the upper casing portion 14, and a keyboard unit 33 located on the right side of the LDC 31.

The grading terminal device bodies 1 are installed in cram schools, and the like, and are intended to enter results of grading made by graders and the like, to perform printing of the entered grading results on answer sheets, to perform tabulation on the grading results, and to transmit and receive the tabulation results.

It should be noted that the upper casing portion 14 and the lower casing portion 15 are hinge connected on the back surface side, thereby being rendered rotatable to each other. In addition, the upper casing portion 14 and the lower casing portion 15 are adapted to be able to remain in the state when the upper casing portion 14 is opened relative to the lower casing portion 15 by installing a damper therebetween.

The sheet storage cabinet 12 is located in the lower portion of the LDC 31, as described above, intended to hold an answer sheet on which a grading result is printed by the grading terminal device body 1, and made up of a bar attached to the front surface of the grading terminal device body 1.

The sheet discharge port 13 is a discharge port from which the answer sheet held in the sheet storage cabinet 12 can be taken out. A clearance in the upper portion of the bar, the sheet storage cabinet 12 acts as the sheet discharge port 13.

The FDD 11 is provided for performing the task of reading allocation grade data given to each question, and grading data including a pattern format indicating a position pattern of an answer column of an answer to be graded which are saved to a flexible disk (hereinafter, referred to as “FD”), a storage medium, and of saving the grading result of the answer to the FD.

It should be noted that the pattern format, the allocation grade data, and the like can not only be read out of the FD, but also entered from the keyboard unit 33, and the like described later by a grader, if necessary.

The LDC 31 is intended to identify and display an answer column to be graded in order to increase efficiency in grading work of an answer by a grader, display grading results and tabulation results thereof, or display data contents read out of the flexible disk. A powerful backlight with adjustable light intensity is disposed in the back portion of the LDC 31 so that an answer sheet is placed on the upper surface of the LCD31, and has a liquid crystal display passed through to be displayed. It should be noted that the LCD 31 may be replaced by a touch panel type organic electroluminescence display, and touch panel type electronic paper.

The keyboard unit 33, as described later, comprises ten key including numeric keys such as “0” to “9,” grading keys consisting of “,” “x,” and “,” cursor keys consisting of “,” and “→” for selecting the cursor position, and an execution key for instructing execution of predetermined processing.

FIG. 2 shows a power connector 21 located in the lower left of the back surface of the lower casing portion 15, a LAN connector 22 located in the upper vicinity of the power connector 21, and mounting screws 23 located in the center of the back surface of the upper casing portion 14.

The power connector 21 is intended to plug a power cord for connecting the grading terminal device body 1 with a power outlet.

The LAN connector 22 is intended to plug a LAN cable for connecting the grading terminal device body 1 with a personal computer (hereinafter, referred to as “PC”), ant the like. It should be noted that the LAN connector 22 may be replaced by a wireless LAN port, an infrared port, and the like.

The mounting screws 23 are intended to mount a model answer board (not shown) on which a model answer to be referenced in grading is placed on the grading terminal device body 1.

It should be noted that a plurality of notches for heat dissipation are provided substantially across the whole area of the back surface of the lower casing portion 15 in order to prevent heat damage of the inner electronic equipment, and the like.

FIG. 3 shows, in addition to the portions shown in FIG. 1, an answer sheet suction port 32 which is located on the back side of the upper surface of the upper casing portion 14, that is, located in the upper portion of the LDC 31, and which sucks an answer sheet on which a grading result is to be printed.

It should be noted that a sheet storage cabinet (not shown) for holding an answer sheet before a grading result is printed is adapted to be mounted in the vicinity of the answer sheet suction port 32. If a grader prepares to put the answer sheet in the sheet storage cabinet prior to printing of the grading result, the answer sheet is adapted to be carried into the grading terminal device body 1 by means of a printer section described later at execution time of printing, and carried out to the sheet storage cabinet 12 after the printing is actually executed.

In addition, the answer sheet suction port 32 has a shutter which opens at the time of carry-in of the answer sheet attached to prevent dust, and the like from entering from the answer sheet suction port 32 into the grading terminal device body 1 in normal times. And, the shutter has a structure to open so as to carry in the answer sheet, after the completion of grading and input.

FIG. 4(A) is a schematic view of the LCD 31 and the keyboard unit 33 provided in the upper casing portion 14 shown in FIG. 1, and the like.

FIG. 4(B) is a detail view of grading operation keys 31A and a guidance section 31B shown in FIG. 4(A).

FIG. 4(A) shows the grading operation keys 31A allocated to the upper left of the LDC 31, the guidance section 31B allocated below the grading operation keys 31A, a setting screen 31C allocated on the downside of the LDC 31, and the key board unit 33.

As shown in FIG. 4(B), the grading operation keys 31A includes a start key 31a to be depressed when grading is started, a previous screen key 31b to be depressed when the previous screen is displayed on the LDC 31, a grade display section 31c for displaying a grade related to an answer to be graded, a subject display section 31d for displaying a subject related to the answer to be graded, a pattern format display section 31e for displaying a pattern format, a utility key (UTY) 31f to be depressed when a grading result is dump list printed, a test printing is made, or calibration of a touch panel is conducted, and a termination key 31g to be depressed when the grading is completed.

Here, there is shown a state in which “5” denoting a fifth grade is displayed on the grade display section 31c, “SS” denoting social studies is displayed on the subject display section 31d, and “F2” denoting a pattern format 2 is displayed on the pattern format display section 31e.

The guidance section 31B includes a number display section 31h for displaying a question number being graded, a grading display section 31i for displaying the number of answers currently being graded, a grading completion display section 31j for displaying the number of the graded answers, and an examinee's number display section 31k for displaying an examinee's number.

Here, there is shown a state in which “Q1” denoting a question number 1 is displayed on the number display section 31h, “0001” denoting 1 of the number of the answers being currently graded is displayed on the grading display section 31i, “0000” denoting 0 of the number of the graded answers is displayed on the grading completion display section 31j, and “ANN50013” denoting an examinee's number is displayed on the examinee's number display section 31k.

Different types of keys in which the grade entered on an answer sheet to be graded which is displayed on the grade display section 31c is entered, a subject displayed on the subject display section 31d is entered, a pattern format displayed on the pattern format display section 31e is entered, or an examinee's number displayed on the examinee's display section 31k is entered are allocated to the setting screen 31C.

Here, there is shown a state in which grade entry keys 33l ranging from “1” to “6” for entering the grade are allocated to the upper left side, subject entry keys 33m of “JP” denoting Japanese, “MATH” denoting mathematics, “SS” denoting social studies, and “SCI” denoting science, are allocated to the middle left side, “F1” to “F4” keys 33n for entering, for example, four pattern formats are allocated to the lower left side, alphabet keys 33o of “A” to “Z”, and arithmetic operation symbol keys 33p of “+,” “−,” “/,” “*,” and “=” are allocated to the right side, and a “close” key 33q for closing the setting screen 31C is allocated to the bottom side.

It is to be understood that the number of subjects, the type of subjects, the number of pattern formats, and the like are illustrative, and are not intended to be limited to these examples. In addition, when the grade, the subject, and the pattern format are being read out of a flexible disk inserted into the FDD 11, a grader does not need to enter them from the setting screen 31C.

In addition, according to the present embodiment, if each key of the LDC 31 recognizes as having been depressed, the recognition is adapted to be informed to a grader by changing the color of the key recognized as having been depressed.

The keyboard unit 33 comprises the ten key 33a including numeric keys from “0” to “9” for entering a correct answer if an incorrect answer is found at the time of grading, a decimal point entry key for entering a decimal point, or period “.,” and a slush entry key for entering “/,” and grading keys 33b including a “” key to be depressed at the time of a correct answer, a “x” key to be depressed at the time of an incorrect answer, and a “ ” key to be depressed when an answer column is empty, cursor keys 33c consisting of “ ” and “ ” to be depressed when answer columns to be graded are switched, an execution key 33d for instructing to execute predetermined processing, and identifying and displaying keys 33e for identifying and displaying the portions in which “,” “x,” and “ ” are given, respectively.

It should be noted that the grading keys 33b are provided with a light emitting device such as LED inside or in the lower portion, and are adapted to be illuminated by the light emitting device when depressed properly.

FIG. 5 is a side view of the grading terminal device shown in FIG. 1, and the like, and a printer section 50 provided therein. It should be noted that the state in which the upper casing 14 and the lower casing 15 are opened to each other is illustrated, for convenience of explanation.

As shown in FIG. 5, the printer section 50 is broadly divided into an upper feed unit 51 provided in the upper casing 14 and a lower feed unit 53 provided in the lower casing 15. The printer section 50 is provided inside the grading terminal device body, and at the same time, on the rear surface side of the LCD 31.

The upper feed unit 51 is provided with a feed roller 56 for carrying in an answer sheet 54 sucked from the answer sheet suction port 32, a carry-in source of the answer sheet, and a feed roller 52 for carrying out the answer sheet 54 carried in by the feed roller 56 to the lower feed unit 53.

The lower feed unit 53 is provided with a lower feed unit sheet inlet port 55 for carrying in the answer sheet 54 carried out from the upper feed unit 51, and a printing section 57 for printing a grading result, and the like on the answer sheet 54 carried in from the lower feed unit sheet inlet port 55. It should be noted that the lower feed unit 53 is provided with a feed roller (not shown) for carrying out the answer sheet 54 printed in the printing section 57 toward the sheet storage cabinet 12, a carry-out destination.

FIG. 6 is a block diagram showing a typical configuration of a grading terminal system including the grading terminal device bodies 1 shown in FIG. 1, and the like.

FIG. 6 shows a state in which a plurality of the grading terminal device bodies 1 are connected to a network 61, such as the internet through LAN cables 62 and PCs 60 connected to the LAN connector 22, respectively.

FIG. 6 shows a state in which the grading terminal device bodies 1 are, in addition to the portions described above, provided with arithmetic control sections 65, such as CPUs, which are responsible for operation control of the grading terminal device bodies 1, grading, and its tabulation.

Specifically, the arithmetic control sections 65 are intended to perform grading and its tabulation to output the grading result and the tabulation result to the LDC 31 based on the data entered from the keyboard unit 33, and the data entered from the LDC 31.

The arithmetic control sections 65 are also intended to drive the FDD 11 in response to depression of the start key 31a included in the grading operation keys 31A of the LDC 31 for instructing to read grading data saved to an inserted flexible disk.

Furthermore, the arithmetic control sections 65 are intended to instruct printing of grading results of answers to the printer section 50 in response to depression of the termination key 31g included in the grading operation keys 31A of the LDC 31.

Moreover, the arithmetic control sections 65 are intended to transmit tabulation results of grading in an own grading terminal device body 1 to other grading terminal device bodies 1, and receive the tabulation results of the grading in the grading terminal device bodies 1 through the PCs 60 and the network 61. The PCs 60 are capable of tabulating examinees' numbers and grading result data from the arithmetic control sections 65, as well as of tabulating examinees' numbers, and grading result data from other arithmetic control sections 65 to accumulate the grading results of each subject for each examinee's number.

It should be noted that the grading data may be transmitted and received through the network 61 in place of entry from the FD or the setting screen 31C. Alternatively, the load on each PC 60 may be reduced by connecting a management server for managing grading data and grading tabulation results to the network 61.

FIG. 7 is a diagram showing an example of pattern formats of the answer sheet 54 graded by the own grading terminal device body 1 shown in FIG. 1, and the like.

FIG. 8 is a diagram showing an example of the grading results of answers written to the answer sheet 54 with the pattern format shown in FIG. 7.

As shown in FIG. 7, the answer sheet 54 is provided with an answer column 7A relative to, for example, selective questions, an answer column 7B relative to descriptive questions, an entry field 7C of an examinee's number, name, and sex, and an entry field 7D of a grader, and a grading result. It should be noted that the answer sheet 54 is broadly divided into two answer columns of a question A and a question B, and is adapted to print subtotal grade points of each of the question A and the question B, and a total grade point of the question A and the question B on the entry field 7D as the grading result.

FIG. 8 shows a state in which any of “,” “x,” and “ ” is printed in the answer column, “NNN 40001” is entered as an examinee's number, “Z. ABC” is printed as a grader, “15” grade points are printed as the subtotal grade points of the question A, “12” grade points as the subtotal grade points of the question B, and “27” grade points as the total grade points of the question A and the question B.

### DESCRIPTION OF OPERATION

Next, the grading terminal device and system operation according to the present embodiment, and a procedure for grading the answer sheet 54 using the same will be described.

FIG. 9 to FIG. 11 are flowcharts showing the procedures of the programs executed in the arithmetic control section 65 shown in FIG. 6.

FIG. 12 is a flowchart showing the procedure of the examinee's number and other authentication processing of the Step S10 shown in FIG. 10.

FIG. 13 is a flowchart showing the procedure of the print-preprocessing of the Step S22 shown in FIG. 11.

FIG. 14 is a flowchart showing the procedure of the print processing of the Step S23 shown in FIG. 11.

FIG. 15 to FIG. 20 are diagrams showing display contents displayed on the LCD 31 when the programs shown in FIG. 9 to FIG. 14 are executed.

First, a title screen display instruction is performed in order to display a title screen on the LCD 31, provided that the power switch 10 is turned on, as shown in FIG. 9 (Step S1a).

Herewith, the title screen as shown in FIG. 15(A) is displayed on the LCD 31. It should be noted that the characters “CML,” and the version information of the grading terminal device body 1 are shown here.

Next, an instruction is given for the FDD 11 to check the presence or absence of FD insertion, and then a judgment is made of whether or not the FD is being inserted based on the response from the FDD 11, provided that the start key 31a is depressed (Step S1b).

As a result of the judgment of the Step S1, if the FD is being inserted, a shift to Step S3 is required. On the other hand, if the FD is not being inserted, a FD insertion prompt screen display instruction is performed in order to prompt the FD insertion to the LCD 31 (Step S2).

Herewith, a FD insertion prompt screen as shown in FIG. 15(B) is displayed. It should be noted that the term “Flexible disk?” is adapted to be displayed, here.

Next, if the FD is being inserted, or a grader inserts the FD to depress the start key 31a or the execution key 33d in response to the FD insertion prompt screen display, a FD save content readout instruction is performed (Step S3).

Then, it is judged whether or not the read FD save contents contain the grading data (Step S4).

As a result of the judgment of the Step S4, if the read FD save contents contain the grading data, a grading data display instruction is performed in order to display the read grading data on the LCD 31 (Step S5).

Herewith, the grading data as shown in FIG. 15(C) and FIG. 15(D) are displayed on the LCD 31. It should be noted that an answer sheet to be graded is of F2 format, and shows an example of questions on Japanese of the fifth grade here.

On the other hand, as a result of the judgment of the Step S4, if the read FD save contents contain no grading data, a grading data entry prompt screen display instruction is performed in order to display a grading data entry prompt screen for prompting to enter the grading data to the grader (Step S6).

Specifically, the grading data entry prompt screen may be displayed by referring to a grade allocation setting management file stored within the arithmetic control section 65, in memory not shown, or the like.

Herewith, the grading data entry prompt screen is displayed on the LCD 31. Then, when the grading data are actually entered by depressing a predetermined key, it is possible to identify the grading data by, for example, coloring the key.

Next, performed is a grader information entry screen display instruction for prompting entry of information on a grader, such as grader's name (Step S7).

Then, when the information on the grader is actually entered, the entered grader information entry screen as shown in FIG. 16(E) to FIG. 16(G) is displayed on the LCD 31. It should be noted that there are shown examples in which grader's name is “Z.ABC,” “ID1,” ID number allocated to the grader being “12345,” “ID2,” ID number allocated to an answer sheet bag containing the answer sheet 54, and the like given to the grader being “01101,” and a class saved to the FD, or an arbitrary class being “N.”

The present embodiment defines that the grader's name should be entered in one character at the beginning of the grader's name, and grader's family name entered after the period, and that in order to avoid an increase in grader's input operation, a period should be put by the arithmetic control section 65 side, provided that one character at the beginning of the grader's name is entered. In addition, it defines a name entry, for example, as not less than 3 characters and not more than 14 characters.

It defines a grader's ID number (ID1) as, for example, five digits, which are entered by that the grader depresses numeric keys 33a.

It defines an answer sheet bag ID number (ID2) as, for example, five digits, of which the breakdown is that a first, and second digits are defined as the room number of a classroom where an examination is conducted, a third digit as an examination subject, and a fourth and fifth digits as the number allocated to the answer sheet bag.

It should be noted that in the case of an input error, the characters indicated by the cursor are adapted to be eliminated by entering the “x” key of the arithmetic operation symbol keys 33p.

The class is a code which classifies students who belong to the same classroom according to an arbitrary attribute, and which is made up of abbreviated characters of the classified name.

Next, it is judged whether or not a setting key 33q′ has been depressed in order to change the display screen of the LCD 31 from the grader information entry screen to the next screen (Step S8).

As a result of the judgment of the Step S8, if the setting key 33q′ has not been depressed, a shift to the Step S8 is required.

On the other hand, if the setting key 33q′ has been depressed, as shown in FIG. 10, in order to see if passing of the answer sheet 54 to the grader contains an error, the examinee's number and other entry prompt screen display instruction is performed to display an examinee's number and other entry prompt screen for prompting to enter the classroom number where the examination has been conducted corresponding to the ID2, class, grade, and the examinee's number (Step S9).

Herewith, the examinee's number and other entry prompt screen as shown in FIG. 17(H) is displayed on the LCD 31.

Next, the examinee's number and other authentication processing for judging whether or not examinee's number, and the like are correctly entered is performed (Step S10).

Here, the examinee's number and other authentication processing is shown in detail in FIG. 12, and the examinee's number and other authentication processing first judges whether or not any key of the previous screen key 31b, alphabet keys 33o or numeric keys 33, and the termination key 31g has been depressed (Step S31).

Here, the present embodiment employs process processing to enable execution of processing appropriate for the depressed keys, and provides recognition in the arithmetic control section 65 of where to go for the next step by changing process flags depending on the depressed keys.

As a result of the judgment of the Step S31, if any key has not been depressed, a shift to the Step S31 is required. On the other hand, if any key has been depressed, and at the same time its key is of the previous screen key 31b, it is judged whether or not the grader information entry screen is currently being displayed (Step S32).

As a result of the judgment of the Step S32, if the grader information entry screen is currently being displayed, a shift to the Step S31 is required. On the other hand, if the grader information entry screen is not currently being displayed, the grader information entry screen display instruction is performed in order to display the grader information entry screen (Step S33).

Herewith, the grader information entry screen is displayed on the LCD 31.

In addition, as a result of the judgment of the Step S31, if any key has been depressed, and at the same time, its key is either the alphabet keys 33o, or the numeric keys 33, it is judged based on grader information previously entered of whether or not the depressed key is authenticated to be a predetermined key (Step S34).

As a result of the judgment of the Step S34, if the depressed key is not authenticated to be the predetermined key, a shift to the Step S31 is made without having to display characters and the like corresponding to the key. On the other hand, if the depressed key is authenticated to be the predetermined key, it is judged whether or not the grader information entry has been completed on the basis of whether or not all keys which are expected to be depressed have actually been depressed (Step S35).

As a result of the judgment of the Step S35, if the grader information entry has been completed, a shift to the Step S11 shown in FIG. 10 is required.

On the other hand, if the grader information entry has not been completed, as shown in FIG. 12, a cursor displayed on the LDC 31 is instructed to move to the right or to the lower portion, as well as the characters or the figures corresponding to the depressed keys are instructed to be displayed on the LDC 31 (Step S36).

Herewith, the characters, and the like are displayed on the grader information entry screen of the LCD 31, as shown in FIG. 17(I) to FIG. 18(M). It should be noted that there is shown a state in which “AN” is displayed as classroom data (FIG. 17(I)), “N” is displayed as class data (FIG. 17(J)), “5” is displayed as a grade (FIG. 17(K)), and an incorrect entry of “0015” is made (FIG. 17(I)), and then a correct entry of “0013” is displayed (FIG. 18(M)) as an examinee's number.

Incidentally, the present embodiment makes an authentication of the examinee's number by performing check digit processing after entry of a fourth digit of the examinee's number. As shown in FIG. 17(L), if the examinee's number is entered by mistake, reentry of a correct examinee's number is prompted by allowing the cursor to move to the beginning of the examinee's number. In addition, as described in the Step S34, if an incorrect key is depressed upon entry of the classroom data, and the like, the characters, and the like corresponding to the incorrect key are prevented from being displayed to free the grader from work such as cursor movement for the sake of its correction.

In addition, as a result of the judgment of the Step S31, if any key has been depressed, and at the same time, its key is of the termination key 31g, a title screen display instruction 37 is performed in order to display the title screen on the LCD 31 (Step S37).

Herewith, the title screen is displayed on the LDC 31, as shown in FIG. 15(A). The answer sheet remains placed on the LCD until this time.

Next, as a result of the judgment of the Step S35, if the entry has been completed, a marker display instruction is performed in order to display the “start grading” shown in FIG. 18(N), followed by putting a marker on an answer column to be graded, provided that the execution key 33d is depressed, and at the same time, a first answer is graded (Step S11).

Herewith, the marker is displayed in the answer column to be graded on the LCD 31, as shown in FIG. 18(O). This marker indicates a grading position of the answer sheet, and the maker position transmits the answer sheet placed. It should be noted that according to the present embodiment, an instruction is performed to display the examinee's number, and the like on the examinee's number display section 31k along with the marker display instruction for informing the grader about the examinee's number, and the like.

Next, a return to FIG. 10 is required again, and it is judged whether or not the grading keys 33b have been depressed (Step S12).

As a result of the judgment of the Step S12, if the grading keys 33b have not been depressed, a shift to the Step S12 is required. On the other hand, if the grading keys 33b have been depressed, in order to inform that effect to the grader, a grading mark display instruction is performed to display a grading mark on the LCD 31, as well as a grading key lighting instruction is performed to light a light emitting device associated with the grading keys 33b (Step S13).

Herewith, the grading mark “,” or “x” is displayed on the LCD 31, as shown in FIG. 18(P) or FIG. 19(R), and the light emitting device associated with the grading keys 33b emits light.

Next, it is judged whether or not the depression of the grading keys 33b have been completed in order to determine whether or not grading mark display, and the like are stopped (Step S14a).

As a result of the judgment of the Step S14a, if the depression of the grading keys 33b have not been completed, a shift to the Step S14a is required. On the other hand, if the depression of the grading keys 33b have been completed, a display stop instruction is performed to stop the display of the grading mark displayed on the LCD 31, as well as a lights-out instruction is performed to turn off the light emitting device associated with the grading keys 33b (Step S14b).

Next, it is judged whether or not an incorrect answer setting such that a grader enters a correct answer, and the like is provided, if an incorrect answer has been found in the answer sheet (Step S15).

As a result of the judgment of the Step S15, if the incorrect answer setting has not been provided, a shift to Step S19 is required. On the other hand, if the incorrect answer setting has been provided, it is judged whether or not the grading keys 33b judged as having been depressed in the Step S12 are of an incorrect key, “x” (Step 16).

As a result of the judgment of the Step S16, if the grading keys 33b are not of the incorrect key, “x”, a shift to the Step S19 is required. On the other hand, if the grading keys 33b are of the incorrect key, “x”, a breakdown entry prompt screen display instruction is performed in order to display a breakdown entry prompt screen for prompting to enter a correct answer, and the like on the LCD 31 (Step S17).

Herewith, the breakdown entry prompt screen is displayed on the LCD 31, as shown in FIG. 19(S). This breakdown entry prompt screen is used for processing of an incorrect answer analysis. In the event of the incorrect answer analysis, besides “x” information for the incorrect answer, information on kinds of incorrect answers is entered by conversion into signs such as figures on the basis of a predetermined correlation table. More specifically, the conversion of the correlation table is such that if the information has no answers, 0 is allocated, and if the information has other numeric values, the numeric values are entered.

It should be noted that the Step S15 to the Step S17 may be executed prior to judgment processing shown in the Step S14a. In this case, the Step S15 should be performed. Where to go in the case of being judged as N in the Step S16, and after the Step S17 is the Step S14a.

Next, it is judged whether or not the setting key 33q′ indicating the completion of a breakdown entry has been depressed in order to change the display screen of the LCD 31 from the breakdown entry prompt screen to the next screen (Step S18).

As a result of the judgment of the Step S18, if the setting key 33q′ has not been depressed, a shift to the Step S18 is required. On the other hand, if the setting key 33q′ has been depressed, it is judged whether or not the grading has been completed, as shown in FIG. 11 (Step S19).

As a result of the judgment of the Step S19, if the grading has not been completed, the position at which the marker is displayed is instructed to move to the next answer column to be graded, as well as a question number displayed on the number display section 31h is advanced by one and then a shift to the Step S19 is required (Step S20).

Herewith, a screen on which the position of the marker is displayed is displayed in an area of the LCD 31 to which the marker is allowed movement from its previous displayed position, as shown in FIG. 19(T).

On the other hand, as a result of the judgment of the Step S19, if the grading has been completed, subtotal and total grade points are respectively calculated on the basis of grade allocation data, and the like read out of the FD, a grade point and check prompt screen display instruction is performed in order to display a screen showing the total grade points and a screen prompting grading check on the LCD 31 (Step S21).

Herewith, a grade point and check prompt screen is displayed on the LCD 31, as shown in FIG. 19(U). It should be noted that an example in which “28 grade points” are displayed is shown here, but that the subtotal grade points may be displayed together.

Then, the print-preprocessing that can execute grading correction, and the like is performed prior to printing grading results on the answer sheet 54 (Step S22).

The detailed print-preprocessing is shown in FIG. 13. It is first judged whether or not any of the cursor keys 33c, the grading keys 33b, the check keys 33e, and the execution key 33d has been depressed (Step S41).

Here, the present embodiment employs the process processing to enable the execution of the processing appropriate for the depressed keys, and provides recognition in the arithmetic control section 65 of where to go for the next step by changing the process flags depending on the depressed keys.

As a result of the judgment of the Step S41, if any of the keys has not been depressed, a shift to the Step S41 is required. On the other hand, any of the keys has been depressed, and the key is of the cursor keys 33c, a cursor movement instruction is performed in order to move the cursor in a direction the cursor keys 33c move, and then a shift to the Step S41 is required (Step S42).

It should be noted that the cursor may be moved to the beginning of the answer column when “1” of the numeric keys 33a is depressed, and moved to the end of the answer column when “9” is depressed.

In addition, as a result of the judgment of the Step S41, if any of the keys has been depressed, and the key is of the grading keys 33b, a grading result obsoleting instruction is performed in order to correct the grading result previously obtained at the cursor position (Step S48).

In addition, as a result of the judgment of the Step S41, if any of the keys has been depressed, and the key is of the check keys 33e, a mark lighting instruction is performed in order to light the mark at the grading point corresponding to the check keys 33e (Step S43).

Herewith, a mark lighting screen at the grading point corresponding to the check keys 33e is displayed on the LDC 31, as shown in FIG. 19(V). This provides easier check of grading results.

Next, it is judged whether or not the depression of the check keys 33e has been completed in order to determine whether or not the mark at the grading point corresponding to the check keys 33e is turned off (Step S44).

As a result of the judgment of the Step S44, if the depression of the check keys 33e has not been completed, a shift to the Step S44 is required. On the other hand, if the depression of the check keys 33e has been completed, a mark lights-off instruction is performed, and then a shift to the Step S41 is required (Step S45).

In addition, as a result of the judgment of the Step S41, if any of the keys has been depressed, and the key is of the execution key 33d, a termination wait screen display instruction is performed in order to display a termination wait screen of grading on the LCD 31 (Step S46).

Herewith, “ ” indicating the termination wait of the grading is displayed in the center of the screen on the LCD 31, as shown in FIG. 20(W). It should be noted that according to the present embodiment, the termination wait screen display instruction is performed, as well as an instruction for counting up the data displayed on the grading completion display section 31j is performed.

Next, the grading data is saved to the FD, or is transmitted to the PCs 60 via the LAN cables 62 prior to printing the grading results on the answer sheet 54, and then a shift to the Step S23 is required (Step S47).

When the aforementioned print-preprocessing shown in FIG. 13 is completed, a return to FIG. 11 is required, and the print processing for printing the grading results on the answer sheet 54 is performed (Step S23).

This print processing is shown in detail in FIG. 14. In the print processing, a PRINT display instruction is first performed in order to display the term, “PRINT” indicating that printing is in progress on the LCD 31 (Step S52).

Herewith, the term “PRINT” is displayed on the LCD 31, as shown in FIG. 20(X).

Then, the device judges whether or not the answer sheet 54 is set in the sheet storage cabinet in the vicinity of the answer sheet suction port 32 after the answer sheet graded by the grader is allowed movement upwardly in a direction of “ ” displayed in the center of the screen of the LCD 31, provided that the grading results are ready for printing on the answer sheet 54 (Step S53).

As a result of the judgment of the Step S53, if the answer sheet 54 has not been set in the sheet storage cabinet in the vicinity of the answer sheet suction port 32, a shift to the Step S53 is required. On the other hand, if the answer sheet 54 has been set in the sheet storage cabinet in the vicinity of the answer sheet suction port 32, a carry-in instruction is performed so that the answer sheet 54 is carried in from the answer sheet suction port 32 to the printing section 57 located inside the lower feed unit sheet inlet port 55 of the lower feed unit 53 by the feed rollers 56 and 52 of the upper feed unit 51 in order to print the grading results on the answer sheet 54 in the printer section 50 (Step S54).

Next, a printing instruction is performed so that the grading results are printed on the carried-in answer sheet 54 (Step S55).

The grading results entered by the grader are then printed on the carried-in answer sheet 54.

Next, a carry-out instruction is performed in order to carry out the printed answer sheet 54 from the printer section 50 (Step S56).

As a result, the printed answer sheet 54 is kept in the sheet storage cabinet 12, and becomes ready for removal from the sheet discharge port 13.

After this, the display stop instruction is performed in order to stop displaying the term “PRINT” on the LCD 31, and then a shift to the Step S24 shown in FIG. 11 is required.

Next, it is judged whether or not the termination key 33g has been depressed in order to determine whether the answer sheet with the same contents as those described above is continued to be graded, or completed to be graded (Step S24).

As a result of the judgment of the Step S24, if the termination key 33g has been depressed, the grading of the answers sheet is stopped, and then a shift to the Step S1a is required. On the other hand, if the termination key 33g has not been depressed, a shift to the Step S9 is made to continue to grade the answer sheet to the same questions in the same pattern format.

It should be noted that if a paper jam and the like occur in the printer section 50, it is only necessary to make test printing by depressing the utility key 31f.

Next, after the grading results to all answers have been transmitted to each PC 60, any of the PCs 60 or the management server, and the like tabulate all the grading results through the network 61.

And, individual grading results for each subject graded by each grading machine are associated with each individual examinee's number to be tabulated to generate data for preparing a comprehensive academic achievement table including total grade point values, ranking, standard scores, and the like, and data for preparing an individual academic achievement table. The generated data are transmitted to each PC 60, or a host terminal not shown through the network 61. In this way, each PC 60 provides access to the comprehensive academic achievement table, printout, and the like without having to use the manpower.

### BRIEF DESCRIPTION OF THE DRAWINGS

FIG. 1 is a front view of a grading terminal device embodying the present invention.

FIG. 2 is a back view of the grading terminal device shown in FIG. 1.

FIG. 3 is a top view of the grading terminal device shown in FIG. 1.

FIG. 4 is a schematic view (a) and an enlarged view of part thereof (b) of a LCD 31 and a keyboard unit 33 provided in the upper casing portion 14 shown in FIG. 1, and the like

FIG. 5 is a side view of the grading terminal device and the printer section 50 provided therein shown in FIG. 1, and the like

FIG. 6 is a block diagram showing a typical configuration of a grading terminal system including the grading terminal device bodies 1 shown in FIG. 1, and the like.

FIG. 7 is a diagram showing an example of a pattern format of an answer sheet 54 graded by the own grading terminal body 1 shown in FIG. 1, and the like.

FIG. 8 is a diagram showing an example of a grading result of an answer written in the answer sheet 54 with the pattern format shown in FIG. 7.

FIG. 9 is a flowchart showing a program procedure executed by the arithmetic control section 65 shown in FIG. 6.

FIG. 10 is a flowchart showing a program procedure executed by the arithmetic control section 65 shown in FIG. 6.

FIG. 11 is a flowchart showing a program procedure executed by the arithmetic control section 65 shown in FIG. 6.

FIG. 12 is a flowchart showing a procedure of the examinee's number and other authentication processing of the Step S10 shown in FIG. 10.

FIG. 13 is a flowchart showing a procedure of the print-preprocessing of the Step S22 shown in FIG. 11.

FIG. 14 is a flowchart showing a procedure of the print processing of the Step S23 shown in FIG. 11.

FIG. 15 is a diagram showing display contents displayed on a LCD 31 in the case of executing the programs shown in FIG. 9 to FIG. 14, and illustrating a title screen (a), a FD insertion prompt screen (b), a grading data readout screen (c), and a grading data readout screen enlarged view (d).

FIG. 16 is a diagram showing display contents displayed on a LCD 31 in the case of executing the programs shown in FIG. 9 to FIG. 14, and illustrating a grading information entry screen (e), a grader information screen enlarged view (f), and a grader information screen enlarged view (g).

FIG. 17 is a diagram showing display contents displayed on a LCD 31 in the case of executing the programs shown in FIG. 9 to FIG. 14, and illustrating grading data entry screens (h) to (l).

FIG. 18 is a diagram showing display contents displayed on a LCD 31 in the case of executing the programs shown in FIG. 9 to FIG. 14, and illustrating a grader information entry screen (m), and grading screens (n) to (q).

FIG. 19 is a diagram showing display contents displayed on a LCD 31 in the case of executing the programs shown in FIG. 9 to FIG. 14, and illustrating a grading screen (r) and breakdown entry prompt screens (s) to (v).

FIG. 20 is a diagram showing display contents displayed on a LCD 31 in the case of executing the programs shown in FIG. 9 to FIG. 14, and illustrating a grading completion wait screen (w), a print processing screen (x), and a printing preparation completion screen (y).

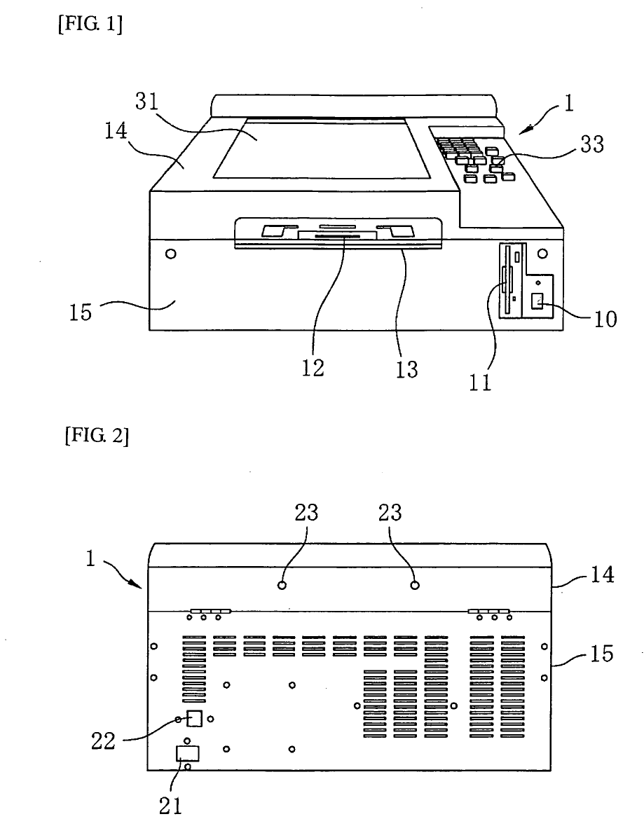

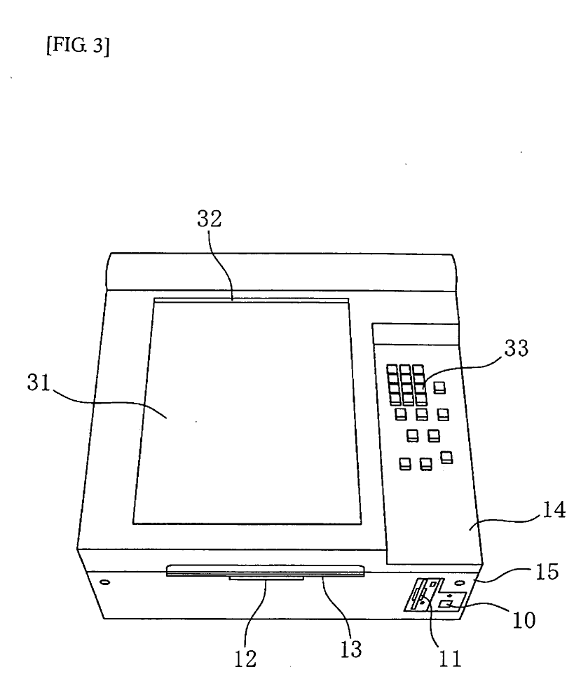

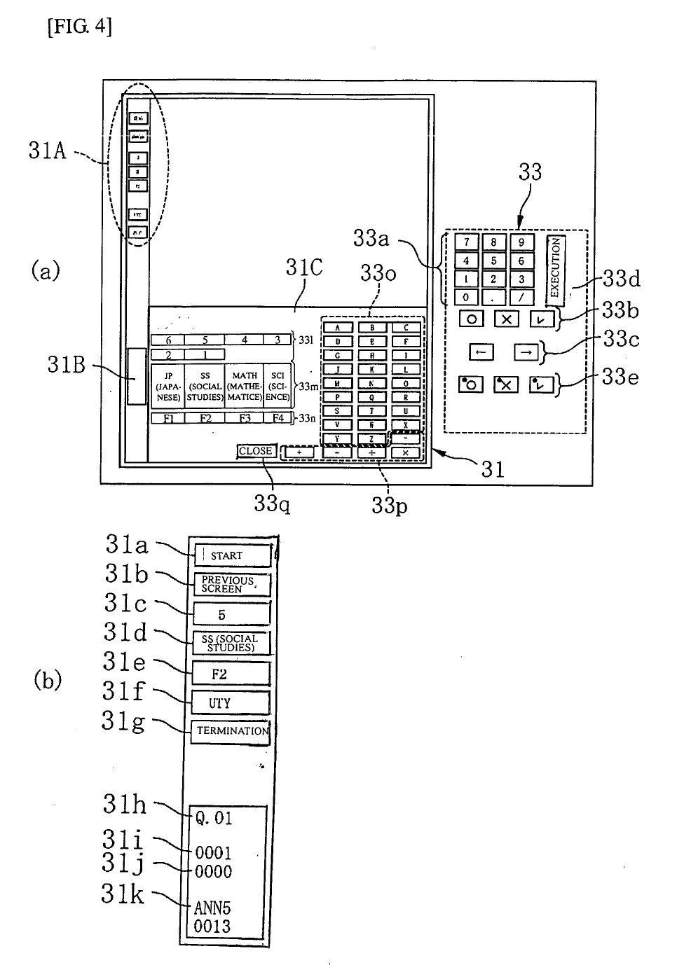

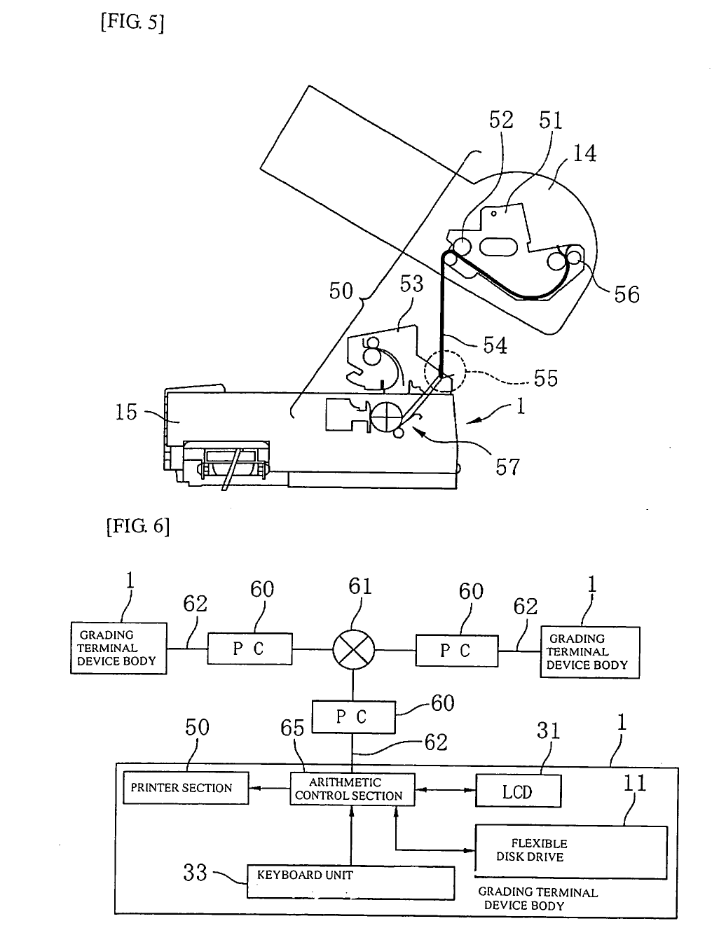

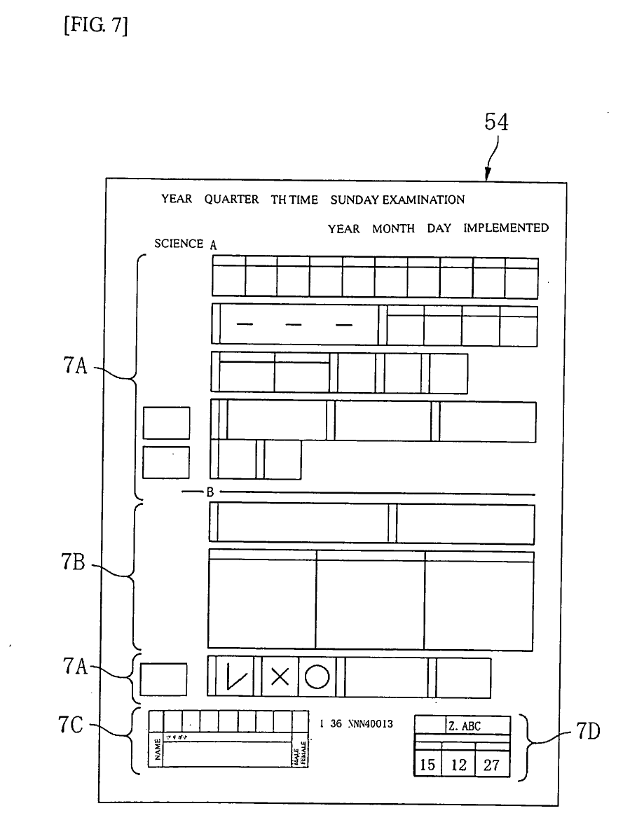

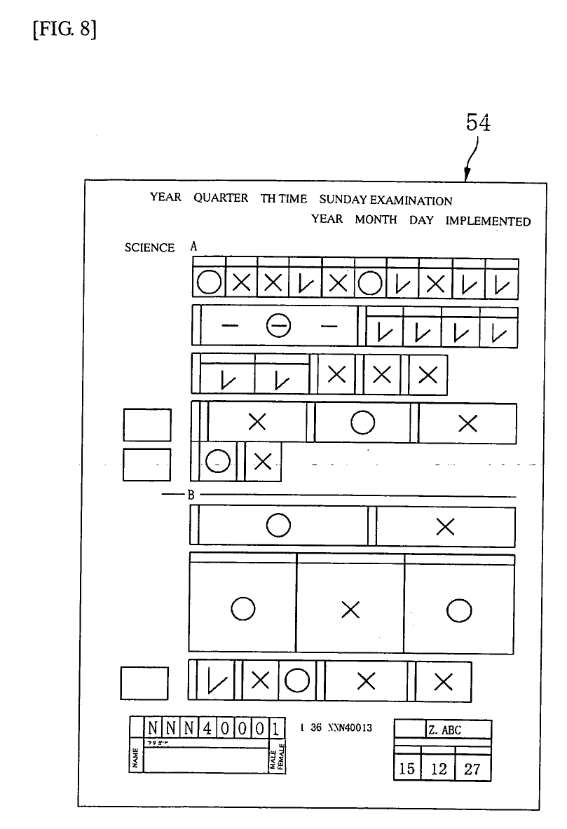

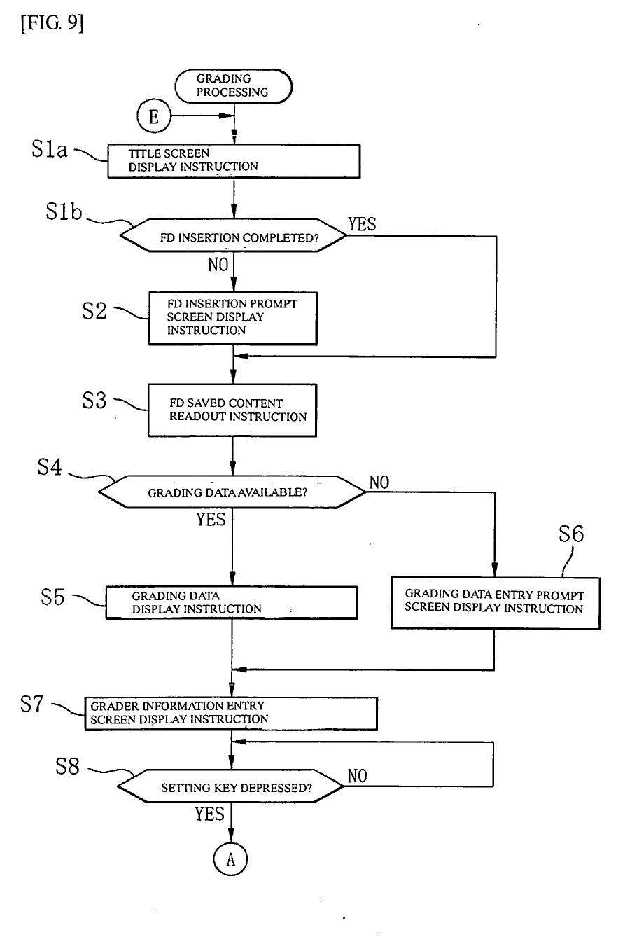

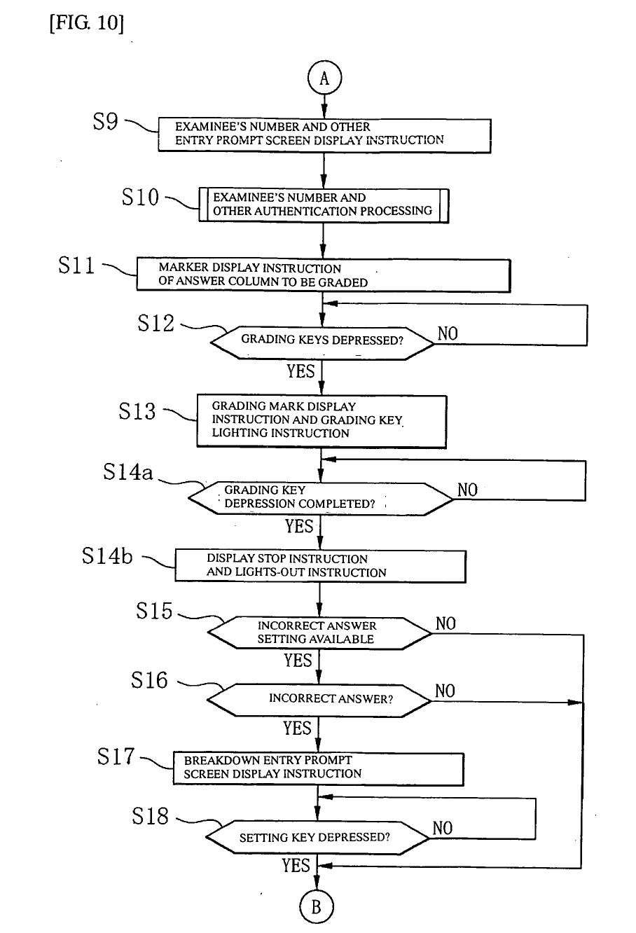

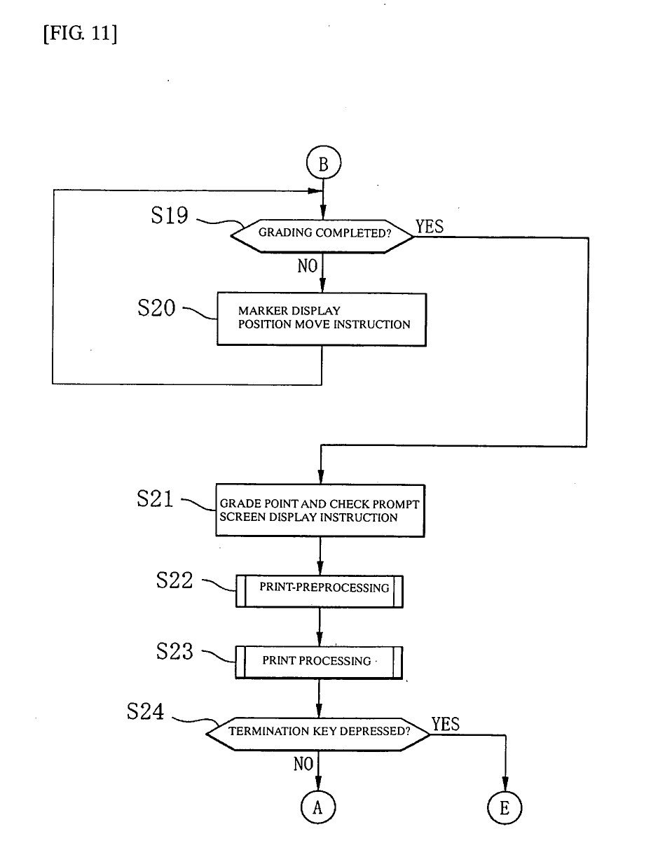

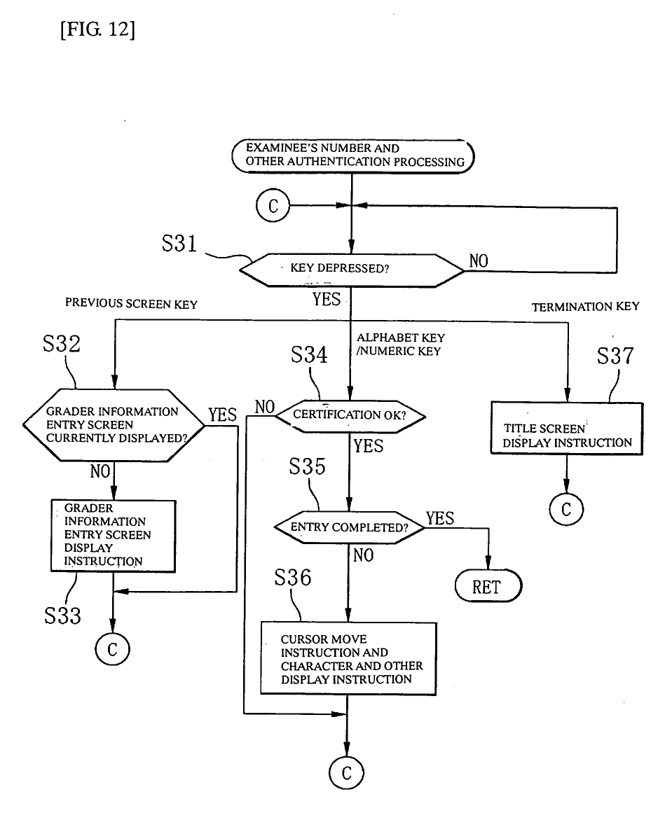

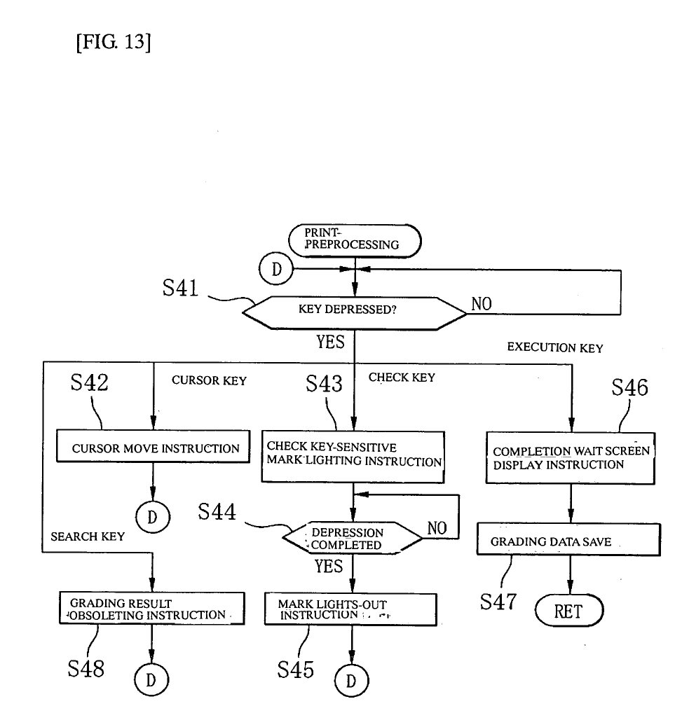

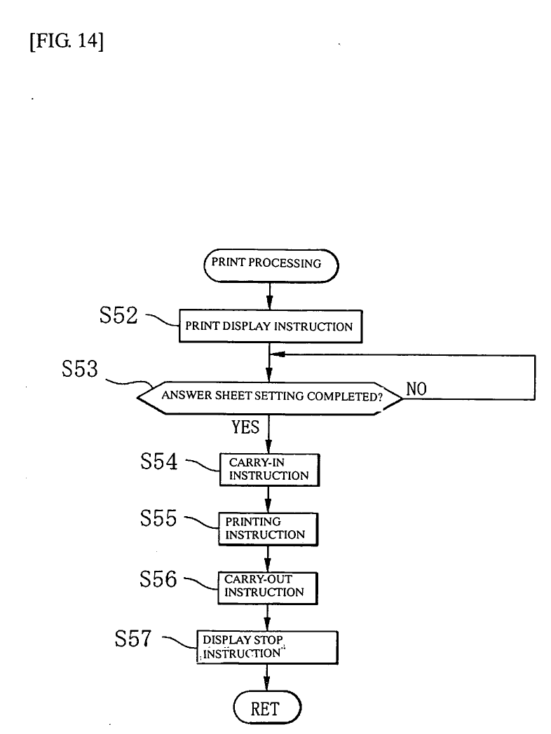

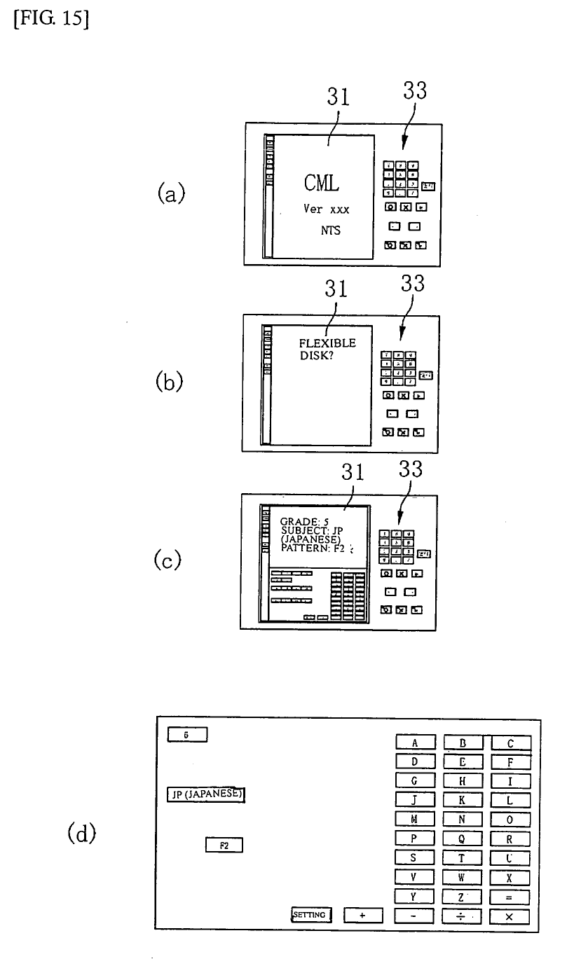

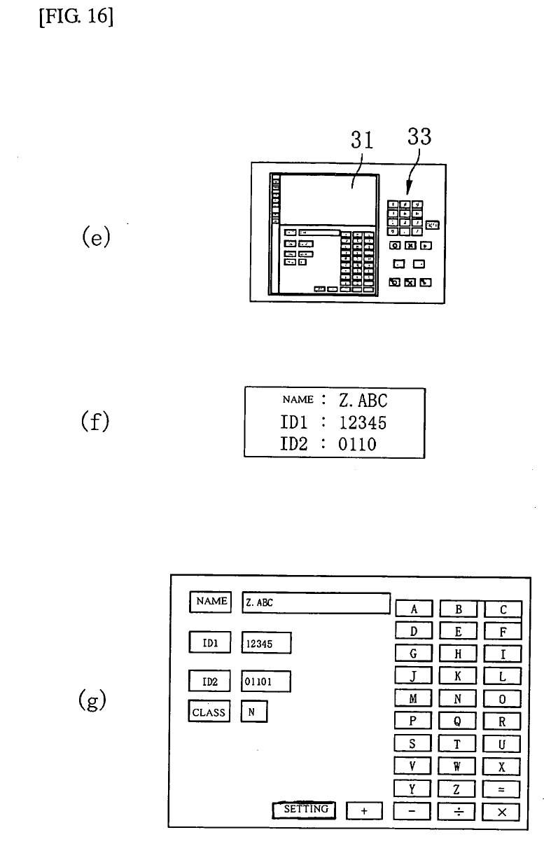

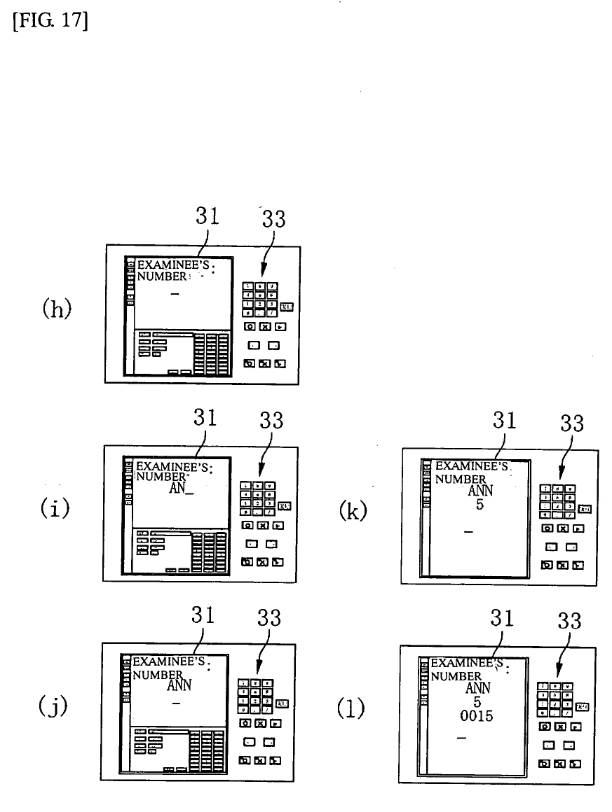

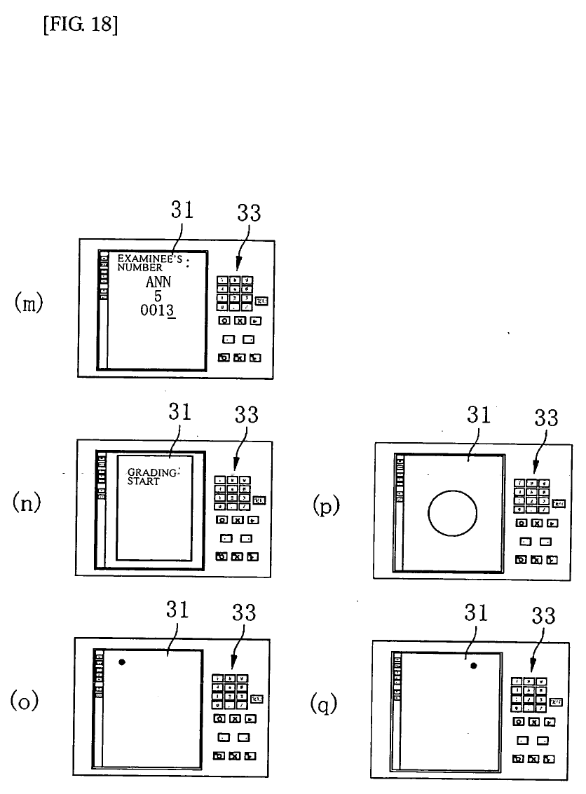

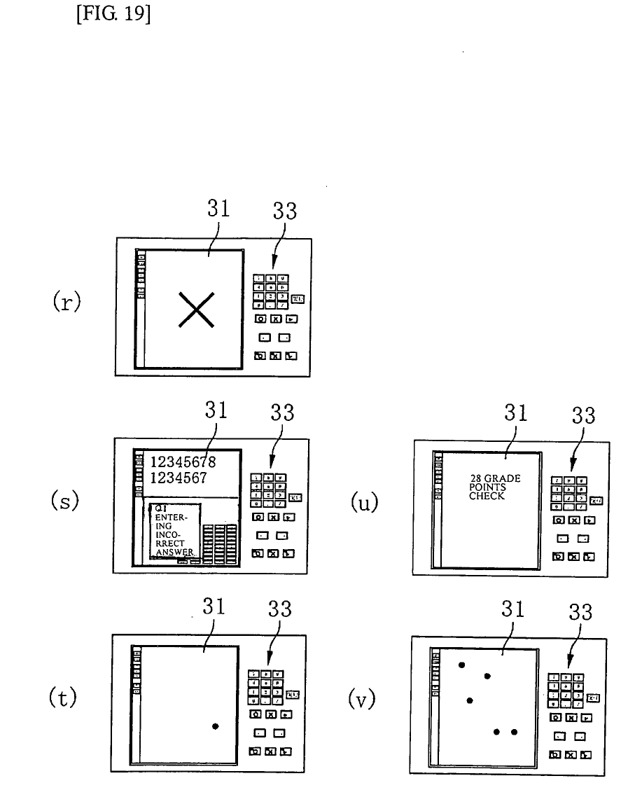

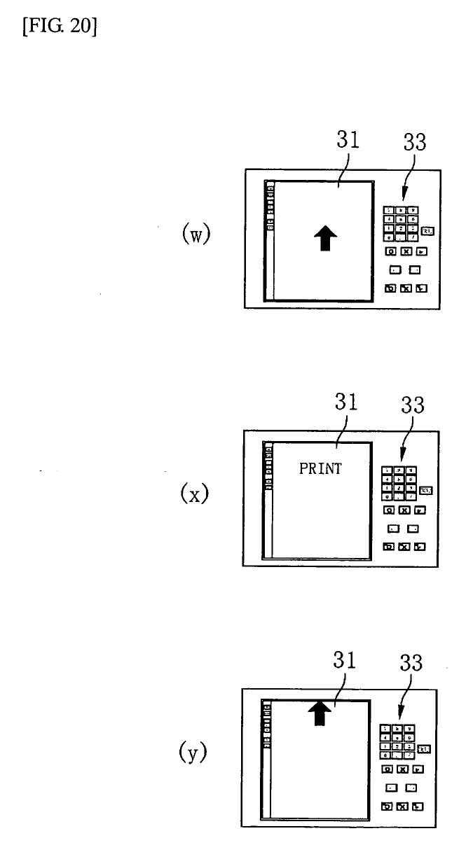

### EXPLANATION OF THE REFERENCE NUMERALS

1 GRADING TERMINAL DEVICE BODIES
2 POWER SWITCH
11 FDD
12 SHEET STORAGE CABINET
13 SHEET DISCHARG PORT
14 UPPER CASING PORTION
15 LOWER CASING PORTION
21 POWER CONNECTOR
22 LAN CONNECTOR
23 MOUNTING SCREWS
31 LCD
31A GRADING OPERATION KEY
31B GUIDANCE SECTION
31C SETTING SCREEN
31a START KEY
31b PREVIOUS SCREEN KEY
31c GRADE DISPLAY SECTION
31d SUBJECT DISPLAY SECTION
31e PATTERN FORMAT DISPLAY SECTION
31f UTILITY KEY
31g TERMINATION KEY
31h NUMBER DISPLAY SECTION
31i GRADING DISPLAY SECTION
31j GRADING COMPLETION DISPLAY SECTION
31k EXAMINEE'S NUMBER DISPLAY SECTION
31l GRADE ENTRY KEY
32 ANSWER SHEET SUCTION PORT
33 KEYBOARD UNIT
33a TEN KEY
33b GRADING KEY
33c CURSOR KEY
33d EXECUTION KEY
33e IDETIFYING/DISPLAYING KEY
33m SUBJECT ENTRY KEY
33n “F1” TO “F4” KEYS
33o ALPHABET KEY
33p ARITHMETIC OPERATION SYMBOL KEY
33q CLOSE KEY
50 PRINTER SECTION
51 UPPER FEED UNIT
52 FEED ROLLER
53 LOWER FEED UNIT
54 ANSWER SHEET
55 LOWER FEED UNIT SHEET INLET PORT
56 FEED ROLLER
57 PRINTING SECTION
61 NETWORK
62 LAN CABLES
60 PCs
65 ARITHMETIC CONTROL SECTION
7A ANSWER COLUMN
7B ANSWER COLUMN
7C ENTRY FIELD
7D ENTRY FIELD

1-11. (canceled)

12. A grading terminal device, comprising:
a grading terminal device body provided with an upper casing portion and a lower casing portion;
a sheet storage cabinet located in the center of a front surface of the grading terminal device body;
a sheet discharge port located in an upper portion of the sheet storage cabinet;
an arithmetic control section, such as CPU, which is responsible for operation control of the grading terminal device body, grading, and its tabulation inside the grading terminal device body;
a flexible disk drive located rightward of a front surface of the lower casing portion, and connected to said arithmetic control section;
a power switch provided in the vicinity of said flexible disk drive;
a liquid crystal display section with a touch panel provided in the center of an upper surface of the upper casing portion, and connected to said arithmetic control section;
a keyboard unit located on the right side of said liquid crystal display section, and connected to said arithmetic control section;
a printer which is provided inside said grading terminal device body, and at the same time, on the rear surface side of said liquid crystal display section, and connected to said arithmetic control section, and which comprises an upper feed unit sucking an answer sheet from a suction port to carry in with a roller, and a lower feed unit provided with a printing section; and
memory connected to said arithmetic control section,
characterized in that the answer sheet is placed on the liquid crystal display section, said liquid crystal display section identifying and displaying an area which is stored in the memory and is corresponding to an answer column to be graded among the answer columns provided on the answer sheet, as well as displaying a question number corresponding to the area, and an examinee's number entered on said answer sheet,
characterized in that said touch panel enters a grading result of an answer entered in the answer column corresponding to the area identified and displayed on the display section, and
characterized in that said printer carries said answer sheet into the sheet storage cabinet in the vicinity of the suction port to print the grading result entered by said grading result entry section, followed by carrying-out thereof through the upper feed unit and the lower feed unit.

13. The grading terminal device according to claim 12, characterized in that said printer section is provided inside the grading terminal device body, and at the same time, on a rear surface side of said display section, a carry-in source of said answer sheet is provided with an answer sheet suction port 32 which sucks an answer sheet on which a grading result is to be printed on a back side of an upper surface of said upper casing portion, and at the same time, in an upper portion of said display section, and a carry-out destination is rendered a lower portion of said display section.

14. The grading terminal device according to claim 12, comprising:
an arithmetic control section in which a grade point of the answer entered on said answer sheet is calculated based on the grading result entered by said grading result entry section, and preset allocation grade data, and the calculated grade point is output to a network to which a plurality of grading terminal device bodies are connected to each other, as well as a grade point of an answer entered on other answer sheet output from the network side is entered.

15. The grading terminal device according to claim 12,
characterized in that said display section is a touch panel type display section, allowing at least one entry, or one display of said examinee's number, information for identifying a grader who makes said grading, a grade of an examinee who has entered the answer on said answer sheet, an examination subject of the examinee, and a format of said answer column.

16. A grading terminal system, comprising:
a network in which the grading terminal devices according to claim 12 are connected to each other to communicate grade points calculated in said each grading terminal device; and
information processing equipment in which said each grading terminal device and said network are relayed to transmit the grade points output from said each grading terminal device to said network side to output the grade points transmitted from the network side to the each grading terminal device.

17. The grading terminal device according to claim 13, comprising:
an arithmetic control section in which a grade point of the answer entered on said answer sheet is calculated based on the grading result entered by said grading result entry section, and preset allocation grade data, and the calculated grade point is output to a network to which a plurality of grading terminal device bodies are connected to each other, as well as a grade point of an answer entered on other answer sheet output from the network side is entered.

18. The grading terminal device according to claim 13,
characterized in that said display section is a touch panel type display section, allowing at least one entry, or one display of said examinee's number, information for identifying a grader who makes said grading, a grade of an examinee who has entered the answer on said answer sheet, an examination subject of the examinee, and a format of said answer column.

19. The grading terminal device according to claim 14,
characterized in that said display section is a touch panel type display section, allowing at least one entry, or one display of said examinee's number, information for identifying a grader who makes said grading, a grade of an examinee who has entered the answer on said answer sheet, an examination subject of the examinee, and a format of said answer column.

20. A grading terminal system, comprising:
a network in which the grading terminal devices according to claim 13 are connected to each other to communicate grade points calculated in said each grading terminal device; and
information processing equipment in which said each grading terminal device and said network are relayed to transmit the grade points output from said each grading terminal device to said network side to output the grade points transmitted from the network side to the each grading terminal device.

21. A grading terminal system, comprising:
a network in which the grading terminal devices according to claim 14 are connected to each other to communicate grade points calculated in said each grading terminal device; and
information processing equipment in which said each grading terminal device and said network are relayed to transmit the grade points output from said each grading terminal device to said network side to output the grade points transmitted from the network side to the each grading terminal device.

22. A grading terminal system, comprising:
a network in which the grading terminal devices according to claim 15 are connected to each other to communicate grade points calculated in said each grading terminal device; and
information processing equipment in which said each grading terminal device and said network are relayed to transmit the grade points output from said each grading terminal device to said network side to output the grade points transmitted from the network side to the each grading terminal device.
